(19) United States
(12) Patent Application Publication
(10) Pub. No.: US 2021/0177004 A1
(43) Pub. Date: Jun. 17, 2021

(54) Carbonated Frozen Dessert

(71) Applicant: Brigham Young University, Provo, UT (US)

(72) Inventors: Michael L. Dunn, Salem, UT (US); Frost M. Steele, Orem, UT (US)

(73) Assignee: Brigham Young University, Provo, UT (US)

(21) Appl. No.: 17/251,049

(22) PCT Filed: Aug. 7, 2019
(86) PCT No.: PCT/US2019/045506

§ 371 Date: Dec. 10, 2020

Related U.S. Application Data
(60) Provisional application No. 62/716,280, filed on Aug. 8, 2018.
(60) Provisional application No. 62/722,696, filed on Aug. 24, 2018.

(51) Int. Cl. A23G 9/40; A23G 9/34; A23G 9/06; A23G 9/42

(52) U.S. Cl. CPC A23G 9/40; A23G 9/42; A23G 9/06; A23G 9/34

(57) ABSTRACT

Hardpack frozen desserts providing a carbonation sensation even after frozen storage over an extended shelf life, and methods of making such hardpack frozen desserts are described. Hardpack frozen desserts have a particular solute content, providing a solute molarity of at least 1.0 molar, and/or a solute molality of at least 0.78 molal, and/or an Aw of the mixture of 0.91 or less.

### CROSS-REFERENCE TO RELATED APPLICATIONS

This application claims priority to U.S. Provisional Patent Application No. 62/716,280 filed Aug. 8, 2018, entitled “Carbonated Hard-Pack Ice Cream Formulation and Packaging”, and U.S. Provisional Patent Application No. 62/722,696 filed Aug. 24, 2018, entitled “Insulative Packaging Film for Frozen Food Packaging”, both of which are incorporated herein by reference in their entirety.

### BACKGROUND

Carbonated drinks, such as soft drinks and carbonated water, are an enjoyable experience for many consumers. Consumers enjoy the sensation of drinking carbonated drinks partly due to the carbon dioxide bubbles, but also due to reaction of the carbon dioxide bubbles with carbonic anhydrase on the tongue that converts carbon dioxide and water into carbonic acid, which is then detected by a receptor on the tongue that detects pain. Although consumers are able to detect carbonic acid in a drink without the formation of bubbles, bubbles can enhance the experience of the carbonation sensation. Carbonation sensation is generally pleasant when carbonic acid is detected by the tongue at low levels, but can become unpleasant or painful if the levels of carbonic acid detected by the tongue are too high.

Various beverages and liquid foods, such as refrigerated yogurt, have been successfully produced. However, carbonated frozen food products with extended shelf life, where the produce is manufactured, stored, and distributed in a frozen state have not yet been successfully produced.

### SUMMARY

The present disclosure relates to frozen carbonated dessert and methods of making a frozen carbonated dessert.

Provided herein is a hardpack frozen dessert. The hardpack frozen dessert includes a mixture including a base component and a solute component that includes at least one sweetener, and carbon dioxide distributed within the mixture, wherein the hardpack frozen dessert provides a carbonation sensation upon eating. The solute component is included in an amount sufficient to provide at least one of: a solute molarity of the mixture of at least 1.0 molar, a solute molality of the mixture of at least 0.78 molal, and an Aw of the mixture of 0.91 or less.

In some embodiments, the at least one sweetener can be included in an amount that does not exceed 40 g sucrose equivalent per 100 g of the mixture. In some embodiments, the at least one sweetener can be included in an amount that provides about 10 g to about 20 g sucrose equivalent per 100 g of the mixture. In some embodiments, the at least one sweetener can include a sugar alcohol. In some embodiments, a sugar alcohol can include glycerol, erythritol, xylitol, mannitol, sorbitol, maltitol, lactitol, or any combination thereof In some embodiments, the at least one sweetener can include allulose.

In some embodiments, a base component can include a milk product.

In some embodiments, a hardpack frozen dessert can have sufficient carbon dioxide to provide an overrun of at least 20%. In some embodiments, a hardpack frozen dessert can have sufficient carbon dioxide to provide an overrun of about 50% to about 150%.

In some embodiments, a hardpack frozen dessert can be an ice cream, an ice milk, a gelato, a frozen yogurt, or a frozen custard. In some embodiments, a hardpack frozen dessert can be a sorbet or fruit-based frozen dessert.

In some embodiments, a hardpack frozen dessert can retain a carbonation sensation over a shelf life at −15° C. for at least 2 months.

In some embodiments, a hardpack frozen dessert can have a drip through melt rate that achieves at least 20% melt by weight within 35 minutes.

In some embodiments, a hardpack frozen dessert can be packaged in a hermetically sealed container. In some embodiments, a hermetically sealed container can be configured to moderate temperature of the hardpack frozen dessert.

Also provided herein is a method of making a hardpack frozen dessert. A method provided herein includes providing a mixture including a base component and a solute component that includes at least one sweetener, applying carbon dioxide to the mixture, such that the carbon dioxide is distributed within the mixture, to produce a mass of carbonated mixture, and chilling the carbonated mixture at a temperature of −15° C. or less for sufficient time to achieve a temperature of −15° C. or less throughout the mass. The solute component is included in an amount sufficient to provide at least one of: a solute molarity of the mixture of at least 1.0 molar, a solute molality of the mixture of at least 0.78 molal, and an Aw of the mixture of 0.91 or less.

In some embodiments of a method provided herein, carbon dioxide can be applied as a gas to the mixture at a rate of about 1 cc to about 4 cc of carbon dioxide per gram of mixture. In some embodiments of a method provided herein, carbon dioxide can be applied in an amount sufficient to achieve an overrun of about 50% to about 150%. In some embodiments of a method provided herein, carbon dioxide can be applied as a pressurized gas to a moving stream of the mixture. In some embodiments of a method provided herein, carbon dioxide can be applied as a carbon dioxide-enriched atmosphere in contact with a surface of the mixture. In some embodiments of a method provided herein, carbon dioxide can be applied by sparging the mixture with the carbon dioxide.

In some embodiments of a method provided herein, the method can further include packaging the carbonated mixture.

These and various other features and advantages will be apparent from a reading of the following detailed description.

### DETAILED DESCRIPTION

The present disclosure relates to a carbonated frozen dessert in hardpack form. In an initial attempt to produce a carbonated hardpack frozen dessert, the inventors put carbonated soft serve-type ice cream into hermetically sealed containers to prevent escape of carbon dioxide, then froze the carbonated soft serve ice cream to a core temperature of −15° C. or less to achieve a hardpack ice cream. However, upon opening and consuming the resulting product, little to no carbonation sensation was detected. The inventors initially believed that the amount of carbonation in the soft serve was insufficient to provide carbonation sensation in the hardpack form, so the amount of carbonation was increased such that in soft serve form, the product was nearly painful to eat rather than pleasant, then put into hermetically sealed containers and frozen to a core temperature of −15° C. or less to achieve a hardpack ice cream. Surprisingly, even with such high levels of carbon dioxide, little to no carbonation sensation was observed in the hardpack ice cream.

It was discovered and is newly described herein that a hardpack frozen dessert that provides a carbonation sensation upon eating can be made by carbonating a mixture having a solute component in an amount sufficient to provide a solute molarity of the mixture of at least 1.0 (e.g., at least 1.2 molar) molar, or a solute molality of at least 0.78 molal (e.g., at least 0.9 molal) prior to freezing. Alternatively, a hardpack frozen dessert that provides a carbonation sensation can be made by carbonating a mixture having a solute component in an amount sufficient to provide a water activity (i.e., Aw) of the mixture of about 0.91 or less (e.g. about 0.90 or less). Without being bound to theory, it is believed that a solute content as described herein provides sufficient water in liquid form for carbon dioxide to exist as carbonic acid in a hardpack state (e.g., temperature throughout of −15° C. or less). Conversely, a solute content less than described herein is believed to result in excessive crystallization of free water into ice, limiting the amount of liquid water available to react with carbonic anhydrase on the tongue, while also allowing carbon dioxide gas to escape the product in a hardpack state. The combination of these effects are believed to lead to insufficient conversion of carbon dioxide to carbonic acid until the product is too warm to be enjoyed by the consumer as a frozen dessert.

As used herein, a “carbonation sensation” refers to detection of an amount of carbon dioxide or carbonic acid upon placement on the tongue. The amount of carbon dioxide or carbonic acid that is detectable may vary in different formulations of a hardpack frozen dessert described herein. However, carbonation sensation is generally recognized as the sensation of carbonic acid detected by receptors on the tongue. Carbonation sensation is frequently described as a biting sensation or slight burning sensation on the tongue of a human consumer. The level of perceived carbonation sensation generally increases as a function of the amount of carbon dioxide or carbonic acid in a product. For example, in sugar free soft drinks, 3 volumes of carbon dioxide per volume liquid at 35° F. provides what is considered a moderate carbonation sensation, while 3.5 volumes of carbon dioxide per volume liquid at 35° F. provides what is considered a strong carbonation sensation. It has been reported that the threshold for detection of carbon dioxide or carbonic acid in a refrigerated yogurt is about 181 to about 390 parts per million (Wright, et al. (2003) Determination of Carbonation Threshold in Yogurt. Journal of Food Science, 68 (1), 378-381). Generally, unless indicated otherwise, as used herein, the term carbon dioxide described as distributed within a mixture, refers to either gaseous carbon dioxide (e.g., as bubbles within the mixture) or carbonic acid dissolved within the mixture.

A human consumer may experience a carbonation sensation upon eating a hardpark frozen dessert as described herein upon placing the dessert, at least a portion of which is in frozen form in their mouth. The frozen dessert may generally be at a temperature less than 4° C. when placed in the consumer's mouth, such as a temperature ranging from −15° C. to 0° C. In practice, the frozen hardpack dessert may begin melting as soon as dispensed to the consumer for consumption. According, the frozen hardpack dessert placed in the mouth of the consumer to provide the carbonation sensation may include a portion that is frozen and a portion that is liquefied.

A hardpack frozen dessert is described herein. A hardpack frozen dessert described herein can resemble any hardpack frozen dessert, such as an ice cream, a frozen custard, an ice milk, a sorbet, a frozen yogurt, a gelato, or any other hardpack frozen dessert, except that it provides a carbonation sensation upon eating. In some embodiments, a hardpack frozen dessert described herein can provide a carbonation sensation upon eating over a shelf life at −15° C. of at least 2 months (e.g., at least 4 months). In some embodiments, a hardpack frozen dessert described herein can be packaged (e.g., in a hermetically sealed package) to help maintain the carbonation sensation over shelf life.

A hardpack frozen dessert described herein comprises a mixture of a base component and a solute component, and carbon dioxide, either as a gas or as carbonic acid, distributed within the mixture. As used herein, a base component can be any food ingredient suitable for a hardpack frozen dessert that provides water to the mixture. Examples of a base component can include a dairy milk ingredient (e.g., milk, reduced fat milk, cream, and the like, or any combination thereof), a non-dairy milk ingredient (e.g., nut-based milk, grain-based milk, seed-based milk, and the like, or any combination thereof), a fruit or vegetable ingredient (e.g., juice, puree, or the like, or any combination thereof), an egg ingredient (e.g., whole egg, egg yolk, egg white, or the like, or any combination thereof), a flavored water, and the like, and combinations thereof. As used herein, the term “milk product” refers to both dairy and non-dairy milk ingredients.

A solute component in a hardpack frozen dessert described herein may include sufficient solute content that are soluble in water to achieve a solute molarity of at least 1.0 molar (e.g., at least 1.1 molar, or at least 1.2 molar) within the mixture, and/or or a solute molality of at least 0.78 molal (e.g., at least 0.8 molal, at least 0.85 molal, or at least 0.9 molal) within the mixture, and/or a water activity (Aw) of about 0.91 or less (e.g., about 0.905 or less, or about 0.90 or less).

As used herein, solute molarity refers to the sum of moles of solute components within a liter of mixture. As used herein, solute molality refers to the sum of moles of solute components within a kg of mixture. Both solute molarity and solute molality can be calculated based on the molecular weight of the combined solute content included in the mixture. As used herein, Aw is measured using the chilled-mirror dew point technique using a water activity meter, such as an AquaLab water activity meter (Decagon Devices, Inc., Pullman, Wash., USA).

A solute component can contain any food appropriate solute, such as salts (e.g., sodium chloride, sodium citrate, calcium chloride, potassium chloride, and the like), sugars (e.g., monosaccharides, disaccharides, trisaccharides), sugar alcohols (glycerol, erythritol, xylitol, mannitol, sorbitol, maltitol, lactitol, and the like), and the like, or any combination thereof. Preferably, a solute included in a solute component has a molecular weight of less than 550 g/mol (e.g., less than 400 g/mol), to increase contribution of the solute to freezing point depression, which increases the water available for carbon dioxide to exist as carbonic acid when the mixture is in a hardpack state. Generally, solutes with a lower molecular weight (e.g., glycerol, sodium chloride, and the like) have a greater positive impact on the water available for carbon dioxide to exist as carbonic acid when the mixture is in a hardpack state relative to solutes with a higher molecular weight (e.g., oligosaccharides, polyglycerols, and the like) on an equal mass basis.

In some embodiments, a solute providing or contributing to a solute component can come from the base component. For example, lactose in a dairy milk ingredient base component can contribute to a solute component. Similarly, naturally occurring sucrose and fructose in a fruit or vegetable ingredient base can contribute to a solute component.

A solute component described herein may contain at least one sweetener, such as a sugar and/or a sugar alcohol. Suitable sweeteners include, for example, glucose, fructose, sucrose, allulose, honey, corn syrup, sugar alcohols (glycerol, erythritol, xylitol, mannitol, sorbitol, maltitol, lactitol, and the like), and the like, and any combination thereof In some embodiments, a high intensity sweetener can be included in a solute component. While high intensity sweeteners typically don't contribute much to solute content before they become too intense, they do allow solutes with lesser sweetness intensity to be used at higher concentrations. Lactose can be included in a solute component, especially if it is included as a component of a dairy milk ingredient. However, lactose can sometimes contribute to a sandy texture if added in excess.

In some embodiments, sweeteners included in a mixture can be included in an amount that does not exceed 40 g sucrose equivalent per 100 g of the mixture. In some embodiments, sweeteners included in a mixture can be included in an amount that provides about 10 g to about 20 g sucrose equivalent per 100 g of the mixture. In some embodiments, solute content can be adjusted to achieve the desired molarity, molality, and/or Aw and the desired sucrose equivalent by using solutes with lower relative sweetness than sucrose (e.g., salts or sweeteners with a lower relative sweetness, see, Table 1). This approach can be used to make a hardpack frozen dessert that provides the desired carbonation sensation while also keeping the dessert within a sweetness level preferred by consumers. In some cases, this approach can be used to achieve a higher or lower sucrose equivalent, depending on the sweetness preferences of the targeted consumer.

As used herein, sucrose equivalent refers to the level of sweetness a sweetener or a combination of sweeteners provides to a mixture relative to an amount of sucrose, with sucrose having a sweetness of 1. For example, a sweetener or a combination of sweeteners that provide 20 g sucrose equivalent per 100 g of a mixture provide a sweetness to the mixture that is similar to the sweetness provided by 20 g sucrose per 100 g of mixture.

Sucrose equivalent is calculated by multiplying the content of each sweetener in a mixture by its relative sweetness, then adding the results together. A perceived sweetness can be modified by other ingredients, but as used herein, sucrose equivalent is calculated in the absence of these factors. Table 1 provides relative sweetness to be used for calculating sucrose equivalent herein for several sweeteners suitable for use in a hardpack frozen dessert described herein. Relative sweetness of other sweeteners is known in the art, and where ranges are available for a given sweetener not listed in Table 1, sucrose equivalent calculation should be based on the highest level in the range.

| Sweetener | Relative sweetness |
|---|---|
| Sucrose | 1 |
| Glucose | 0.75 |
| Fructose | 1.7 |
| Lactose | 0.15 |
| Maltose | 0.3 |
| Glycerol | 0.8 |
| Erythritol | 0.65 |
| Xylitol | 1 |
| Mannitol | 0.5 |
| Sorbitol | 0.55 |
| Maltitol | 0.9 |
| Lactitol | 0.4 |
| Allulose | 0.7 |
| Honey | 1.1 |
| Maple syrup | 1 |

In some embodiments, sweeteners included in a mixture can contribute fewer available calories relative to the same mass of sucrose, or no calories. Examples of sweeteners with reduced or no available calories relative to sucrose include, without limitation, erythritol, allulose, xylitol, mannitol, sorbitol, maltitol, and lactitol. High intensity sweeteners can also be used to sweeten a hardpack frozen dessert to limit available calories, however, as discussed above, high intensity sweeteners typically don't contribute much to solute content before they become too intense.

In some embodiments, a sweetener or combination of sweetener can be selected based on a desired flavor profile of the sweetener or combination of sweeteners. For example, lactitol, allulose, and/or sorbitol may be selected to be included in a solute component because they have a flavor profile similar to sucrose. In another example, erythritol may be selected to be included in a solute component due to its comparable sweetness profile to sucrose. In another example, glycerol can provide a larger impact on freezing point depression per gram added due to its low molecular weight. Glycerol is preferably used in combination with another sweetener due to its low relative sweetness.

In some embodiments, additional ingredients can be included in a mixture provided herein. For example, fats (e.g., milk fat, vegetable oils, butter, and the like), hydrocolloids (e.g., gums, gelatin, and the like), flavorants (e.g., vanilla, cocoa, other natural flavors, artificial flavors, fruit juices, and the like), colorants (e.g., natural or artificial colorants, and the like), other components (e.g., nonfat dry milk, starches, condensed milk, proteins, whey, buttermilk powder, fruit pieces, and the like), and combinations thereof, can be included in a mixture to provide a desired flavor, texture, nutritional content, or visual appearance to a hardpack frozen dessert. Additional ingredients need not contribute to solute content (e.g., fats, gums, and the like).

Carbon dioxide can be applied to a mixture herein using any appropriate method to produce a mass of carbonated mixture that can be chilled to produce a hardpack frozen dessert where the carbon dioxide is distributed within the mixture. For example, carbon dioxide can be applied as a pressurized gas (e.g., at least 80%, at least 90%, at least 95%, or about 98% by volume carbon dioxide) distributed or otherwise intermixed into a stream of a mixture (other compositional ingredients forming the hard pack composition). In another example, carbon dioxide can be applied as a carbon dioxide-enriched atmosphere (e.g., at least 80% by volume carbon dioxide) over a volume of mixture that is being agitated. In another example, a volume of a mixture can be sparged with a gas enriched with carbon dioxide (e.g., at least 80% by volume carbon dioxide). Although less preferred due to reduced temperature control, in some embodiments, carbon dioxide can be applied as dry ice to a mixture.

An amount of carbon dioxide and a method of applying carbon dioxide to a mixture to make a mass of carbonated mixture can be selected to achieve a desired overrun. In some embodiments, carbon dioxide can be applied to a mixture to achieve an overrun of at least 20%, or an overrun of from about 20% to about 300% (e.g., from about 40% to about 250%, or from about 50% to about 150%). As used herein, “overrun” refers to the volume of a carbonated mixture relative to the mixture before application of carbon dioxide. An overrun of 50% indicates that a carbonated mixture has a volume 50% higher than the mixture before application of carbon dioxide. An overrun of 100% indicates that the volume of a carbonated mixture is double that of the mixture before application of carbon dioxide. In some embodiments, carbon dioxide gas can be applied to a mixture at a rate of about 1 cc to about 4 cc (e.g., about 2 cc to about 3 cc) per gram of mixture.

Applying carbon dioxide to a combination of the other compositional ingredients forming the hard pack composition provides a carbonated mixture. The carbonated mixture can then be chilled to a temperature of about −15° C. or less for sufficient time to achieve a temperature of about −15° C. or less throughout the mass to produce a hardpack frozen dessert. Chilling can be performed using any appropriate method. For example, a carbonated mixture can be chilled in a single step to a temperature of about −15° C. or less. In another example, a carbonated mixture can first be chilled to a temperature of 0° C. or less (e.g., about −10° C. to about 0° C., or about −4° C.), and then further chilled to a temperature of about −15° C. or less.

Any suitable equipment or combination of equipment can be used to chill a carbonated mixture to produce a hardpack frozen dessert. For example, a carbonated mixture can be chilled by pumping the carbonated mixture through cooled pipes and/or by chilling the carbonated mixture in a blast freezer.

A hardpack frozen dessert provided herein can start melting relatively quickly following removal from a freezer. It is believed that a quick initiation of melting can enhance the carbonation sensation delivered by a hardpack frozen dessert shortly after removal from a freezer. See, e.g., Example 1 below. In some embodiments, a hardpack frozen dessert provided herein can have a drip through melt rate that achieves at least 20% melt by weight within 35 minutes (e.g., within 30 minutes, or within 20 minutes). As used herein, a drip through melt rate is measured using the following method: hardpack frozen dessert is packed into a container having a truncated cone shape with a height of 64 mm, a top diameter of 90 mm, and a bottom diameter of 55 mm, the bottom having a temporary seal; the hardpack frozen dessert is leveled off to a flat surface at the top of the container, and the weight of the hardpack frozen dessert is measured; the hardpack frozen dessert in the container is hardened in a −21° C. freezer for at least 2 days; the hardpack frozen dessert is removed from the freezer, the bottom seal of the container removed, and placed with the open bottom on a U.S. No. 8 sieve positioned over a balance within 1 minute of removal from the freezer; and recording the mass that has melted from the hardpack frozen dessert every five minutes over a period of time (e.g., 60 minutes).

In some embodiments, a hardpack frozen dessert can have a hardness of less than 5000 kg (e.g., 3000 kg or less). As used herein, hardness is measured using a TA-XT2 Texture Analyzer (Stable Micro Systems, Ltd., Godalming, Surrey, United Kingdom). Briefly, the hardpack frozen dessert is packed into an 8 fluid oz paper cup having a truncated cone shape with a height of 2.125 inches, a top diameter of 3.75 inches, and a bottom diameter of 2.75 inches. The top of the hardpack frozen dessert is leveled off to a flat surface at the top of the cup, and the weight of the hardpack frozen dessert is measured. The hardpack frozen dessert in the cup is hardened in a −21° C. freezer for at least 2 days. The hardpack frozen dessert in the cup is taken directly from the freezer and placed on the measuring platform of a TA-XT2 texture analyzer, and tested within 40 seconds of removal from the freezer by penetrating the hardpack frozen dessert with a flat-end knife probe (1 mm thick 4.6 cm wide, and 7.0 cm long), with probe set 2.00 mm above the sample, a penetration speed of 2.00 mm/sec, to a penetration depth of 15.00 mm. Hardness is recorded as the peak force in kilograms.

In some embodiments, a hardpack frozen dessert provided herein can be packaged. In some embodiments, a carbonated mixture can be packaged before chilling to about −15° C. or less. In some embodiments, a carbonated mixture can be chilled in a first step, then further chilled to a temperature of about −15° C. or less following packaging.

Any suitable packaging can be used for a hardpack frozen dessert. In some embodiments, a hardpack frozen dessert can be packaged in a hermetically sealed container to improve the shelf life over which the hardpack frozen dessert retains the ability provide a carbonation sensation upon eating. Suitable hermetically sealed containers include, for example, metal cans, or plastic bottles or cups. In some embodiments, the material used in a packaging can be selected to limit carbon dioxide diffusion through the sidewall of the material. A particularly useful hermetically sealed container can include a removable top that is sufficiently sized to allow a consumer to use a spoon to retrieve the hardpack frozen dessert from the container. Containers sized to provide an amount of hardpack frozen dessert in an amount suitable for a single serving are also particularly useful. One appropriate example of a container suitable for packaging a hardpack frozen dessert provided herein can be found in U.S. Provisional Patent No. 62/722,696.

In some embodiments, a package can be configured to moderate the temperature of a hardpack frozen dessert within the package. For example, a package can include an insulation layer to slow warming of a hardpack frozen dessert within the package once it is removed from a freezer. In another example, a package can be configured to initiate a controlled melting of a hardpack frozen dessert within the package once it is removed from a freezer to enhance the carbonation sensation delivered by the hardpack frozen dessert upon eating.

The following examples describe embodiments of the inventive carbonated hardpack frozen desserts and methods.

### EXAMPLES

### Example 1

A commercial ice cream mix was used to make a hardpack ice cream as a control. The commercial ice cream mix was modified as indicated in Table 2 to produce two embodiments of hardpack frozen desserts according to the invention (Sample 1 and Sample 2). Table 2 shows the solute content of each formulation, the solute molarity, the solute molality, the Aw, and the sucrose equivalent.

TABLE 2

| | Commercial | Sample | Sample |
|---|---|---|---|
| | Mix | 1 | 2 |
| Lactose (from milk ingredients) | 6.85 | 5.72 | 5.54 |
| (% by weight mix) | | | |
| Sweetener blend (sucrose/high | 18.7 | 15.3 | 14.8 |
| fructose corn syrup blend; % | | | |
| by weight mix) | | | |
| Sucrose (in addition to | 0 | 5 | 4.8 |
| sweetener blend; % by weight | | | |
| mix) | | | |
| Sorbitol (% by weight mix) | 0 | 8.6 | 8.3 |
| Glycerol (% by weight mix) | 0 | 0 | 3 |
| Sodium chloride (% by weight | 0 | 0.21 | 0.25 |
| mix) | | | |
| Solute molarity (mol/L) | 0.66 | 1.24 | 1.63 |
| Solute molality (mol/kg) | 0.56 | 0.97 | 1.28 |
| Aw (average, two | 0.930 | 0.906 | 0.897 |
| measurements) | | | |
| Sucrose equivalent (g per | 11.6 | 14.2 | 16.2 |
| 100 g mix) | | | |

The mixtures from Table 2 were pumped as streams through a soft serve ice cream machine and combined with high pressure carbon dioxide from a carbon dioxide tank at a rate of about 3.5 cc to 3.8 cc carbon dioxide per gram mix to produce carbonated mixtures at about −4° C. having an overrun of about 140-145%. Samples of the carbonated mixtures were packaged in hermetically sealed metal cans and chilled until the temperature throughout reached about −21° C. to produce hardpack frozen desserts.

Drip through melt rates for each hardpack frozen dessert were measured according to the method described above. Table 3 shows the average results of the drip through melt rates based on two measurements. The approximate time to 20% melt by weight was calculated based on the melt rate (in % melt per minute) at the first time where both measurements for a sample exceeded 20% melted by weight.

TABLE 3

| | Commercial | | Sample | | Sample | |
|---|---|---|---|---|---|---|
| | Mix | | 1 | | 2 | |
| Temperature of | −21.2° | C. | −21.3° | C. | −21.2° | C. |
| sample | | | | | | |
| Starting mass | 151 | g | 139 | g | 132 | g |
| of sample | | | | | | |
| Ambient | 23.8° | C. | 23.8° | C. | 25.6° | C. |
| temperature | | | | | | |
| Time where | 45 minutes | | 35 minutes | | 25 minutes | |
| 20% melt | with | | with | | with | |
| by weight | 22.1% melt | | 23.6% melt | | 29.1% melt | |
| exceeded | | | | | | |
| Time to 20% | 41 | minutes | 30 | minutes | 17 | minutes |
| melt by weight | | | | | | |
| (calculated) | | | | | | |

| | | | |
|---|---|---|---|
| Average rate of | 8.5 | 11.6 | 12.3 |
| melt over 75 | | | |
| minutes from | | | |
| time 0 (% | | | |
| loss per | | | |
| minute) | | | |

Hardness for each hardpack frozen dessert were measured according to the method described above. The commercial mix had an average hardness over two measurements of about 29,000 kg, while Sample 1 had a hardness over four measurements ranging from about 2395 kg to about 2720 kg and Sample 2 had a hardness over four measurements ranging from about 1175 kg to about 1500 kg.

Samples of each hardpack were tasted using a tasting panel with 10 members, and the carbonation sensation was judged on a scale of 0-5, with 0 being no perceived carbonation sensation and 5 being a carbonation sensation that is too intense. The carbonation sensation was judged over time at a room temperature of 21° C. following removal from a −20° C. freezer. The carbonation sensation for the hardpack frozen dessert made from the commercial mix provided little to no carbonation sensation, with an average score of 0.2 at time 0 and an average score of 0.9 at 20 minutes. Both Sample 1 and Sample 2 provided a pleasant carbonation sensation, with Sample 2 providing a more rapid onset and slightly more intense carbonation sensation. The carbonation sensation of Sample 1 was most intense at about 15-20 minutes after removal from the freezer, and had a slightly more firm texture than Sample 2. Sample 2 provided a carbonation sensation at 5 minutes that was similar to the peak from Sample 1, then increased in intensity until about 15 minutes.

### Example 2

Additional formulations of a hardpack frozen dessert were made according to the invention, including hydrocolloids (guar and acacia gum), various levels of fat, and various sugar alcohols (sorbitol, mannitol, lactitol). Hydrocolloids and fat level variations had little effect on carbonation sensation, but modulated texture. Sorbitol, mannitol, and lactitol were similarly effective in producing a product that provides a carbonation sensation when solute concentration was achieved according to the described invention without exceeding a desired sweetness.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A hardpack frozen dessert, comprising:
a. a mixture, including:
i. a base component;
ii. a solute component including at least one sweetener, the solute component included in an amount sufficient to provide at least one of:
a) a solute molarity of the mixture of at least 1.0 molar,
b) a solute molality of the mixture of at least 0.78 molal, and
c) an Aw of the mixture of 0.91 or less;
b. carbon dioxide distributed within the mixture, wherein the hardpack frozen dessert provides a carbonation sensation upon eating.

2. The hardpack frozen dessert of claim 1, wherein the at least one sweetener is included in an amount that does not exceed 40 g sucrose equivalent per 100 g of the mixture.

3. The hardpack frozen dessert of claim 2, wherein the at least one sweetener is included in an amount that provides about 10 g to about 20 g sucrose equivalent per 100 g of the mixture.

4. The hardpack frozen dessert of claim 1, wherein the at least one sweetener includes a sugar alcohol.

5. The hardpack frozen dessert of 4, wherein the sugar alcohol comprises glycerol, erythritol, xylitol, mannitol, sorbitol, maltitol, lactitol, or any combination thereof

6. The hardpack frozen dessert of claim 1, wherein the sweetener includes allulose.

7. The hardpack frozen dessert of claim 1, wherein the base component comprises a milk product.

8. The hardpack frozen dessert of claim 1, wherein the hardpack frozen dessert has sufficient carbon dioxide to provide an overrun of at least 20%.

9. The hardpack frozen dessert of claim 8, wherein the overrun is about 50% to about 150%.

10. The hardpack frozen dessert of claim 1, wherein the hardpack frozen dessert is an ice cream, an ice milk, a gelato, a frozen yogurt, or a frozen custard.

11. The hardpack frozen dessert of claim 1, wherein the hardpack frozen dessert is a sorbet or fruit-based frozen dessert.

12. The hardpack frozen dessert of claim 1, wherein the hardpack frozen dessert retains the carbonation sensation over a shelf life at −15° C. for at least 2 months.

13. The hardpack frozen dessert of claim 1, wherein the hardpack frozen dessert has a drip through melt rate that achieves at least 20% melt by weight within 35 minutes.

14. The hardpack frozen dessert of claim 1, wherein the hardpack frozen dessert is packaged in a hermetically sealed container.

15. The hardpack frozen dessert of claim 14, wherein the hermetically sealed container is configured to moderate temperature of the hardpack frozen dessert.

16. A method of making a hardpack frozen dessert, the method comprising:
a. providing a mixture, including:
i. a base component;
ii. a solute component including at least one sweetener, the solute component included in an amount sufficient to provide at least one of:
a) a solute molarity of the mixture of at least 1.0 molar,
b) a solute molality of the mixture of at least 0.78 molal, and
c) an Aw of the mixture of 0.91 or less;
b. applying carbon dioxide to the mixture, such that the carbon dioxide is distributed within the mixture, to produce a mass of carbonated mixture, and
c. chilling the carbonated mixture at a temperature of −15° C. or less for sufficient time to achieve a temperature of −15° C. or less throughout the mass.

17. The method of claim 16, wherein carbon dioxide is applied as a gas to the mixture at a rate of about 1 cc to about 4 cc of carbon dioxide per gram of mixture.

18. The method of claim 16, wherein carbon dioxide is applied in an amount sufficient to achieve an overrun of about 50% to about 150%.

19. The method of claim 16, wherein the carbon dioxide is applied as a pressurized gas to a moving stream of the mixture.

20. The method of claim 16, wherein the carbon dioxide is applied as a carbon dioxide-enriched atmosphere in contact with a surface of the mixture.

21. The method of claim 16, wherein the carbon dioxide is applied by sparging the mixture with the carbon dioxide.

22. The method of claim 16, further comprising packaging the carbonated mixture.
